(19) United States
(12) Patent Application Publication
(10) Pub. No.: US 2002/0194262 A1
(43) Pub. Date: Dec. 19, 2002

(54) System and method for controlling the interruption and resumption of access to WWW pages requiring certain prerequisites

(76) Inventor: D. Scott Jorgenson, San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/844,381

(22) Filed: Apr. 27, 2001

(51) Int. Cl. G06F 15/16

(52) U.S. Cl. 709/203; 709/219

(57) ABSTRACT

The present invention is generally directed to a system and method for controlling the interruption and resumption of access to WWW pages that may require arbitrary prerequisites. A significant feature of the invention is its ability to categorize and remember the URL (including form arguments) of where a user was going when a prerequisite failure of a particular kind occurred. By use of session state, this categorized URL is retained, with others as they are accrued (if any), throughout the session. As soon as an applicable prerequisite is satisfied, the user is automatically (or optionally) directed to the retained target URL categorized as corresponding to the satisfied prerequisite (or to a default URL when there is none such). This resumption is effected regardless of the number of intervening HTTP transactions within the session, and regardless of whether the user has left the immediate context in which the failure occurred.

### BACKGROUND OF THE INVENTION

1. Field of the Invention

The present invention generally relates to networked computer systems, and more particularly to a system and method for controlling the interruption and resumption of access to World Wide Web pages that require certain prerequisites.

2. Discussion of the Related Art

The World Wide Web (WWW or Web) is the aggregate of autonomous, heterogeneous, distributed, collaborative, hypermedia information systems existing on the underlying global computer network known as the Internet. Since 1990 the Web has served as the basis for the construction of a multitude of constituent information systems (“Web sites”), providing countless applications in areas ranging from content publishing to electronic commerce.

Current Web sites are implemented with server computers (“Web servers”) which are accessed over the Internet by client computers (“Web clients”) using the Hypertext Transfer Protocol (HTTP) or its encrypted form (HTTPS). There are many public documents describing various versions, features, and aspects of HTTP. Use of the term “HTTP” herein should be understood to encompass all such versions of HTTP in both its clear and encrypted forms.

A typical interaction between a Web client and a Web server includes several HTTP transactions. For example, when a user of the Web client desires to access a resource on a particular Web site, the user operates Web browser software and indicates a Uniform Resource Locator (URL), which specifies the location of the resource on the Web. From the URL, the browser determines the Internet Protocol address of the Web server for the site and establishes communication with the Web server program at that address. The browser then sends an HTTP request message to the Web server program, containing the URL as well as further metadata and parameters concerning the request.

The Web server program, in turn, resolves the request according to the nature of the resource identified by the URL. This process may be as simple as fetching a static file, or as complicated as executing further application logic to dynamically produce a response. In either case, the resolution (called a “Web page”) is downloaded, along with further metadata regarding the outcome of the transaction, in an HTTP response message from the Web server program to the browser. The browser interprets the HTTP response and typically renders and displays the page to the user.

In most Web sites, such pages are hypermedia (often authored in Hypertext Markup Language, HTML), including embedded URL's referencing other pages. If the user selects such an embedded URL (a “hyperlink”), a new HTTP request is formulated and the process repeats. In this way, multiple interactions like these may occur over time to constitute a cohesive experience of the Web site by the user. Such a collection of consecutive, experientially cohesive interactions with a Web site is called a “session”.

As is known, the HTTP protocol is inherently “stateless,” which means that an HTTP request contains no information about the outcome of a prior request. Therefore, a Web server communicating with a client computer cannot rely on HTTP for maintaining state over a session (i.e., storing information about the stage of processing of the user's overall interaction with the server). Many Web sites are thus faced with the problem of maintaining such “session state” over HTTP, in order to provide a rich, personalized user experience. There are numerous techniques, known in the art, which resolve the problem of session state maintenance. These include techniques for storing session state information at the Web client (called “client-side session state”), as well as techniques for storing session state information at the Web server with reference from the Web client (called “server-side session state”). Use of the term “session state” herein should be regarded as encompassing all session state maintenance techniques, whether client-side or server-side.

In client-side session state solutions, when the server program creates session state information in the process of handling an HTTP request, it provides the data to the browser for retention, as part of the HTTP response. The information is provided by the server program in such a manner that the browser will automatically provide it back to the server program in any subsequent HTTP request(s) whose server processing requires the information. In this way, the client “remembers and reminds” the server of the session state information it needs. Client-side session state solutions are typically enabled by such devices as HTTP cookies and/or URL-embedded arguments.

In server-side session state solutions, when the server program creates session state information in the process of handling an HTTP request, it stores the information locally (that is, on the Web server itself or on a companion computer, such as a database server). The information is stored under a unique reference for the particular user's session. This reference (commonly called a “session ID”) is what is then exchanged with the browser, per any of the devices enabling of client-side session state solutions. The session state information itself is stored server-side, typically using such interprocess storage devices as a database, file system, or shared memory.

Many Web sites require certain procedures to be performed before access to certain Web pages is permitted. These procedures are referred to herein as “prerequisites”. Notable examples include Web sites that provide access to financial or account information (such as online banking systems). In such systems, if a user attempts to access a secure Web page without first logging in (i.e., securely identifying and authenticating oneself), the HTTP response to the user will often comprise a request that the user login. Thus logging-in is a particular prerequisite (an “authentication prerequisite”) for access to such Web pages.

The HTTP response in this case can assume different forms in different systems. For example, the HTTP-standard WWW-Authenticate response header is emitted by some current Web sites, as part of the HTTP-standard “basic authentication scheme”. This scheme is based on classic 2-tuple authentication, consisting of a potentially publicly-known identifier (e.g., a user name) in combination with a generally privately-known authenticator (e.g., a password). When browsers which support the HTTP basic authentication scheme receive such a WWW-Authenticate response header, they typically remember the URL originally requested by the user, while issuing a prompt for the user to submit the 2-tuple. For example, a graphical browser such as Microsoft Internet Explorer or Netscape Navigator will open a dialog box requesting a user name and password. When the user provides the 2-tuple, the original URL is remembered and re-requested from the server by the browser, such that the 2-tuple is passed in the HTTP-standard Authorization request header. If the 2-tuple is invalid, another WWW-Authenticate HTTP response header is issued by the server program; but if it is valid, access to the page is granted (i.e., processing of the page request continues uninhibited, and whatever HTTP response is determined by such processing is returned to the client). Furthermore, the browser typically remembers the 2-tuple and provides it automatically to the server when WWW-Authenticate responses are received on subsequent requests, so that the user is uninterrupted.

In other current systems, the HTTP response (comprising a request that the user login) does not use the HTTP-standard basic authentication scheme. Instead, response content may assume the role of advising and facilitating the login. For example, an HTML document may be downloaded containing an HTML form prompting the user for an identification/authentication 2-tuple. Hidden within the form may be an additional parameter, indicating the original URL the user was requesting. Submitting the form sends the 2-tuple and original URL to the Web site for validation. Should validation fail, a similar form may be returned (perhaps with an error message); but should the validation succeed, an HTTP-standard redirect may be returned, directing the browser to automatically re-request the original URL that was effectively “remembered” within the form. Typically, the user's session state would be updated to mark the user as logged-in, so that subsequent requests would bypass similar login procedures.

A problem with these current techniques for handling login, however, is the limited retention scope they afford the original request URL. In order to resume the original HTTP request which triggered the login challenge, this URL (complete with any original form arguments) must be temporarily stored. But both of the previously-discussed techniques only effectively store the URL and form arguments within the context of the login challenge itself. If the user should need to divert into another context in order to resolve the login challenge, the original request URL is lost to those contexts and cannot be resumed therefrom. One example of such a diversion would be a series of online registration pages, consisting of terms-of-use, a registration form, and a registration confirmation page. Another example would be a series of password-recovery pages, consisting of a password-recovery request form, followed by a confirmation page.

Furthermore, this problem is particularly undesirable when the diversion itself offers an alternate means to resolve the login challenge. Such is the case with the registration example above, in which successful submittal of the registration form would itself immediately suffice for logging-in, such that the original request URL would ideally be resumed right then. With the URL lost to the registration context, though, this is not possible. Instead, a default destination Web page is offered, and the user must manually re-navigate to the original page.

Authentication prerequisites are only one example of prerequisites often placed on various pages by current Web sites. In addition to login activities, there are also other known prerequisites required for accessing certain Web pages. Indeed, some pages may have combinations of prerequisites. For example, in a financial context, a given entity (Web site) may provide certain privileges or services only to users who have established overdraft protection for their accounts. In particular, a user who attempts to pay a bill online which would overdraw his account might be required, not only to be logged-in, but also to have purchased overdraft protection. A logged-in user who submitted an HTTP request for an excessive bill payment, and who had not signed-up for overdraft protection, would then receive from the Web site an HTTP response presenting, not a login challenge, but instead an invitation to signup. This invitation might divert the user into a series of Web pages (terms-of-use, a signup form, a confirmation page), after whose successful completion it would be desired to resume the original payment. Thus this overdraft protection requirement is an example of another type of prerequisite (which is of a general class that may be referred to as “entitlement prerequisites”).

Another general class of prerequisites that exists in current Web sites may be referred to as “workflow prerequisites”. Such prerequisites ensure the user navigates through one or more other Web pages before being allowed to proceed directly to another. Building upon the example of a financial Web site, it may be desired that both online registration and overdraft-protection-signup pages place a prerequisite upon the user of having navigated through a series of content first (e.g., a page of advertisement/marketing information, followed by a page of generic terms-of-use). If a user attempted to access online registration or overdraft protection signup directly, the HTTP response from the Web server program would be the first page in the series. The last page in the series would present a continuation hyperlink to resume (i.e., re-request) the original request.

What all of these kinds of prerequisite have in common is their overall model. A URL (herein called the “target”) is requested of the Web server program by the browser. Before processing the URL, the Web server program checks that various criteria are satisfied (herein called the “prerequisites”), of which there may be an arbitrary number. When a prerequisite check is failed, an HTTP response (herein called a “challenge”) is returned by the Web server program to the browser, presenting notice of the failure and advice regarding how to address it. An indeterminate number of HTTP transactions between the browser and server program then ensues. But subsequently within the same session, one such HTTP request from the browser to the Web server program serves to finally satisfy the previously-failed prerequisite. This event is herein called a “resolution”. It is thus desired that the HTTP response to a resolution (herein called an “invitation”) present the user with an easy way to resume (that is, re-request) the original target. (For example, in some embodiments, the re-request may occur via HTTP redirect, and in other embodiments, via a user-selected hyperlink.)

In handling the problem of prerequisites in general, current Web sites generally suffer the same shortcoming as mentioned specifically in the discussion of the authentication prerequisite, above. This shortcoming is loss of “memory” or “context” as to where a user was, when a given request failed due to a lacking prerequisite. In keeping with the previous example of an entitlement prerequisite, suppose a user was denied access to a certain destination Web page because the user did not possess overdraft protection. Thereafter, and in the same session, the user may electronically signup, so that the overdraft protection requirement is now satisfied. Many current systems would have the signup-confirmation page continue to a default destination URL, rather than the user's particular original URL. This general approach is adequate when a prerequisite is placed on only one target; but it is often the case that the same prerequisite is placed on many targets, so that no one target may be assumed by the system after the resolution. In such systems, the user must manually navigate back to the target Web page that he had attempted to access. Unfortunately, this process may involve traversing a number of intervening Web pages.

Other current systems embed the target URL in the challenge HTTP response, in such a manner that it is passed back to the Web server program should the user select a particular hyperlink on the challenge page. Specific techniques for this approach vary; an example was given above in the discussion regarding the authentication prerequisite. Should a resolution then occur with that next HTTP request, the Web server program would form the invitation based on the target URL, acquired from the HTTP request. Such an approach is adequate when the resolution always occurs no more than one hyperlink downstream from the challenge. However, this approach is insufficient when the resolution occurs many HTTP transactions downstream. Such is the case, for example, with the online registration and overdraft-protection-signup examples given above.

Accordingly, it is desired to provide a general-purpose system and method to control access to Web pages that require certain prerequisites, which overcomes the shortcomings and limitations of the prior art.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve certain advantages and novel features, the present invention is generally directed to a system and method for controlling the interruption and resumption of access to Web pages that may require arbitrary prerequisites. A significant feature of the invention is its ability to categorize and remember the URL (including form arguments) of where a user was going, when a prerequisite failure of a particular kind occurred. By use of session state, this categorized URL is retained, with others as they are accrued (if any), throughout the session. As soon as an applicable prerequisite is satisfied, the user is automatically (or optionally) directed to the retained target URL categorized as corresponding to the satisfied prerequisite (or to a default URL when there is none such). This resumption is effected regardless of the number of intervening HTTP transactions within the session, and regardless of whether the user has left the immediate context in which the failure occurred.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram illustrating the operating environment of a system constructed in accordance with the present invention;

FIG. 2 is a block diagram illustrating certain components of a Web server constructed in accordance with one embodiment of the present invention, for interrupting requested access to a target Web page, when such access is restricted due to failed prerequisites;

FIG. 3 is a flow diagram illustrating the operation of the system shown in FIG. 2, in carrying out an interruption algorithm, according to one aspect of the invention;

FIG. 4 is a block diagram illustrating certain components of a Web server constructed in accordance with one embodiment of the present invention, for resuming requested access to a target Web page, when previously failed prerequisites become satisfied; and

FIG. 5 is a flow diagram illustrating the operation of the system shown in FIG. 4, in carrying out a resumption algorithm, according to one aspect of the invention.

### DETAILED DESCRIPTION OF THE PREFERRED EMBODIMENT

Having summarized various aspects of the present invention above, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

Definitions

Before describing the preferred embodiment of the present invention, several definitions are set out immediately below. To the extent that these terms may have a particular meaning, as a term or art or otherwise, that differs from the definitions set out below, the definitions shall control the interpretation and meaning of the terms as used within the specification and claims herein, unless the specification or claims expressly assigns a differing or more limited meaning to a term in a particular location or for a particular application.

BROWSER is a generic term for a device or platform that allows a user to view a variety of service collections. When used in the context of a Web service, a browser is that tool that requests, receives, and interprets Web pages, and displays the interpreted result on a client workstation display.

HYPERTEXT MARKUP LANGUAGE (HTML) is a document markup language, typically interpreted by Web browsers, that instructs a program how to present a particular display. In this regard, an HTML file includes codes that specify document structure, formatting, text fonts, form elements, etc, ultimately defining how information is to be presented at a client workstation. HTML documents may also embed objects such as graphic files or applets. As is known, various versions of HTML exist.

HYPERTEXT TRANSFER PROTOCOL (HTTP) is a stateless, extensible, generic messaging protocol for conducting request/response transactions between distributed, collaborative, hypermedia information systems (such as a client Web browser and a Web server). The most common HTTP methods (i.e., messaging modes) are GET and POST, which differ in how they transport inputs (such as form arguments) to Web resources. As is known, various versions of HTTP exist, in both unencrypted and encrypted (HTTPS) forms.

INTERNET—An “internet” is a collection of isolated smaller networks into a larger, interconnected entity via the use of an underlying protocol and equipment that employs that protocol. In common usage, “the Internet” (with a capital I) is the well-known, much-publicized worldwide collection of computers and network equipment that use the Internet Protocol to communicate with one another.

SESSION is the extent of a Web browser user's consecutive, experientially-cohesive HTTP transactions with a Web site, bounded by periods of no such interaction. Because HTTP is a stateless protocol, the concept of a “session” is a meta-construct adopted by many Web site applications, and is not reflected in HTTP itself.

SESSION STATE is cumulative data regarding a Web browser user's interaction with a Web site over the course of a session. Session state consists of data that is transacted by a Web site over multiple, discrete HTTP transactions within a session, such that it must be retained between such transactions for subsequent access. Because HTTP is a stateless protocol, the concept of “session state” is a meta-construct adopted by many Web site applications, and is not reflected in HTTP itself.

UNIFORM RESOURCE LOCATOR (URL) is a short string that uses a standard addressing scheme to identify the specific location of a particular Web resource. A fully qualified URL defines the protocol (such as FTP or HTTP), computer name or address, and specific path on that computer to the resource. A URL may also include additional information as input to the resource, such as form arguments (in a query string).

WORLD WIDE WEB (WEB) is the aggregation of all distributed, collaborative, hypermedia information systems on the Internet. Individual such information systems, called Web sites, are heterogeneous and autonomous. Resources provided by Web sites are identified by URLs and accessed over HTTP. Such Web resources produce response content, called Web pages, which are frequently authored in HTML. In general, “the Web” is a subset of all the computers which exist on the “Internet”.

Additional Terms

In addition to the terms defined above, the following terms may be used herein, and these terms should be construed, where the context is appropriate, in accordance with the following definitions.

TARGET refers to any HTTP transaction between a Web client and a Web server regarding a Web resource, which may be interrupted by a prerequisite and resumed following a resolution of the prerequisite. For examples, see PREREQUISITE and RESOLUTION below.

PREREQUISITE refers to any condition associated on a Web server with a target transaction, which condition must have been satisfied by a Web client via a previous applicable resolution in order for the server to continue handling the target transaction. Servers can have multiple prerequisites associated with each target, and vice-versa. When there are multiple prerequisites for a target, all must have resolutions in order for the server to proceed with the target.

As a first example of a prerequisite, a Web server may require that a client have searched a database of prior solutions before handling a particular transaction (e.g., a request to submit a problem report). This search requirement is therefore a workflow prerequisite to the problem report submittal transaction, which is a target.

As a second example of a prerequisite, a Web server may require that a client be authenticated (i.e., reliably identified as a known user) before handling a particular target transaction. This authentication requirement is therefore a prerequisite to each such target.

As a third example of a prerequisite, the same Web server may require that a client also be authorized to a certain degree (i.e., known to have adequate entitlement) before handling the same target transaction. This entitlement requirement is therefore a second prerequisite to each such target.

CHALLENGE refers to any response issued by a Web server to a Web client pursuant to a failed prerequisite on a target transaction requested by the client. A challenge typically informs the user of the client regarding the failure, and invites the user to engage in one or another set of one or more subsequent transactions, any one set of which would, if completed successfully, serve as a resolution for the failed prerequisite.

As a first example of a challenge, after a search prerequisite fails on a problem report submittal target transaction, the Web server may respond with a Web page inviting the user to search the database of prior solutions. This Web page is a challenge in response to the target transaction request.

As a second example of a challenge, after an authentication prerequisite has failed, the Web server may respond with a Web page inviting the user to login or register. This Web page is a challenge.

As a third example of a challenge, after an entitlement prerequisite has failed, the Web server may respond with a Web page inviting the user to purchase entitlement online or identify an existing entitlement already purchased by the user offline (e.g., in the context of a financial Web site, an account; in the context of a support services Web site, a contract; etc.). This Web page is a challenge.

RESOLUTION refers to any Web server event triggered by a transaction (or series of transactions) with a Web client, which event satisfies one or more kinds of prerequisite. Not all resolutions satisfy all kinds of prerequisites. A resolution may be attained by a client subsequent to a challenge, or may be attained independently.

As a first example of a resolution, successful completion of a search against the database of prior solutions is a resolution for the search prerequisite.

As a second example of a resolution, successful login is one possible resolution for an authentication prerequisite. Successful completion of online registration is another possible resolution for an authentication prerequisite.

As a third example of a resolution, successful completion of online purchase is one possible resolution for an entitlement prerequisite. Successful identification of an entitlement previously purchased offline is another possible resolution for an entitlement prerequisite.

INVITATION refers to any response issued by a Web server to a Web client pursuant to a successful resolution, which response contains a particular URL and its form arguments (if any) to be requested by the client. In cases where a previously-requested target was interrupted by a prerequisite now satisfied by the resolution, that target URL and its form arguments (if any) are included in the invitation. In other cases, a default target URL and its form arguments (if any) are included in the invitation instead.

As a first example of an invitation, after the database of prior solutions is searched, the Web server may respond with a search results page that includes a hyperlink for problem report submission. That hyperlink may reference the original URL for the problem report submission target transaction. This search results page is therefore a kind of invitation.

As a second example of an invitation, after successfully logging-in the user, the Web server may respond with an HTTP redirect whose location URL is that of the original target transaction, which was interrupted by an authentication prerequisite. This HTTP redirect is therefore another kind of invitation.

As a third example of an invitation, after successfully registering the user online, the Web server may respond with a confirmation page, which may include a hyperlink to the next page. That hyperlink may reference the URL for the original target transaction which was interrupted by an authentication prerequisite. This registration confirmation page is therefore a kind of invitation.

The foregoing definitions have been provided merely to provide guidance in understanding the description that follows, but should not be construed to impose strict construction limitations upon the claims.

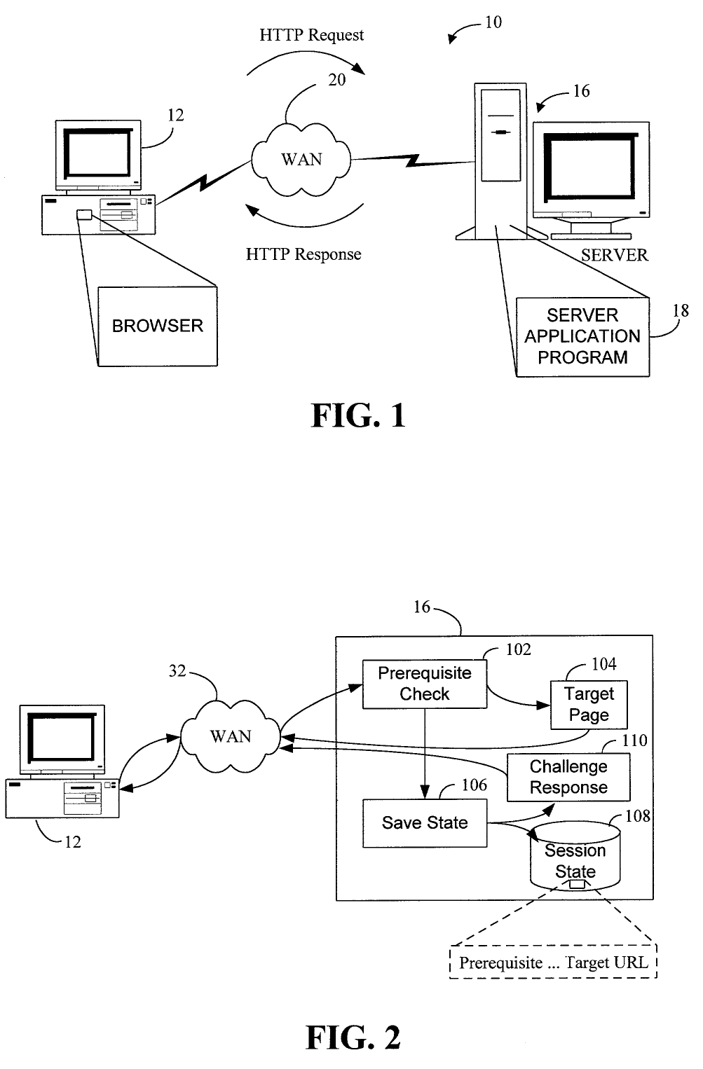

Turning now to the drawings, FIG. 1 is a diagram illustrating components of a system 10, having a client workstation 12 that is in communication with a server computer 16 via a wide area network (WAN) 20, such as the Internet. For purposes of the present invention and the ensuing discussion, it should be understood that the representation of the client workstation 12 and the server computer 16 are provided purely for purposes of illustration, and that the present invention is not limited to a Web browser and server environment. In fact, the concepts and teachings of the present invention are applicable to all computer systems generally, and the depiction of FIG. 1 is provided solely for purposes of illustration.

As illustrated, the client 12 may be executing a browser application 14 that is communicating with a corresponding server application program 18 at the server 16. As is now well known, browser applications are provided and readily available for a variety of client 12 hardware platforms and operating systems. An example of a Web browser application is Microsoft Internet Explorer; another example is Netscape Navigator. Versions of these sample browser applications are generally available for computers based on such diverse microprocessor architectures as the Intel x86, Pentium, and IA-64, Sun SPARC, Hewlett-Packard PA-RISC, and others. Such versions are further generally available for operating systems including Microsoft Windows (95, 98, 2000, NT), Sun Solaris, Hewlett-Packard HP-UX, and others. For purposes of the present invention, client workstation 12 may thus be constituted of any such hardware platform and operating system as provides support for any browser 14. It is the use of such robust and commonly available components that permit the preferred embodiment of the invention to operate across a variety of hardware platforms, and further enhances the expandability of the invention.

Similarly, server 16 and server application program 18 are themselves composed largely of robust and commonly available components. While server application program 18 is custom software in some embodiments of the present invention, in the Web context server application program 18 is frequently a standard HTTP daemon, extended to incorporate the novel algorithm, to be discussed, which facilitates the invention. As is widely known, many such HTTP daemons are publicly available from organizations such as the Apache Software Foundation, Microsoft Corporation, Netscape Communications Corporation, etc. As is further known, these daemons support numerous extension frameworks (including CGI, FastCGI, server API, Java servlets, etc.) for incorporation of application logic encoded in any of various programming languages. These daemons are additionally known to be available for a similar variety of server 16 hardware platforms and operating systems, as previously discussed with respect to client 12. Therefore all combinations of hardware platform, operating system, daemon, extension framework and application programming language are encompassed by the present invention.

As illustrated, a browser transaction (HTTP transaction) generally involves a request and a response. Typically, a client 12 submits an HTTP request that is received and processed by a remote server 16. The server then replies to the request with an HTTP response, and the client/server transaction is complete. In particular, no state information is inherently maintained by the server, as the request/response protocol of HTTP is stateless (i.e., presumes that no ongoing communications will occur between the client 12 and the server 16). Should another HTTP transaction between client 12 and server 16 ensue, for the same user in the same experiential context as the prior transaction, the two transactions may be considered to constitute a session (along with other related transactions that follow). However, as is known, HTTP itself does not facilitate this. Thus, server application program 18 is coded using any of a variety of techniques, widely known in the art, to recognize session affinity and boundaries, and retain session state accordingly. More detail on these interactions, concepts, and techniques has been provided above.

Having illustrated the fundamental environment of the present invention, and before describing the components of the invention itself, a brief example is presented immediately below to help illustrate the context and operation of the present invention. By way of example, consider a financial institution that provides online securities trading. This entity may provide unrestricted access to a number of Web pages. For example, users may be permitted to access and retrieve quotes on stock prices, certain research tools, and other information on this site without any prerequisites or restrictions. However, access to other pages within this site or tools provided through the site may be provided on a restricted basis only. Certainly, the ability to trade securities on a particular account may require a user to be logged in (i.e., reliably known and authenticated). Thus, some pages would have a login, or “authentication” restriction (herein called a “prerequisite”). Other pages may have what may be referred to as an “entitlement” prerequisite. That is, in order for a user to have access to certain research tools and/or broker reports, that user may be required to maintain a certain minimum balance in his or her accounts with that entity. Therefore, access to pages or areas within the site containing broker reports and other research tools may impose dual prerequisites that the user must be logged in and also have a certain minimum balance among his or her accounts with that entity.

Further still, the entity may impose certain “workflow” prerequisites. Hypothetically, and for the purposes of illustration, the entity at the Web server may require that users have viewed and/or accepted certain disclaimers regarding margin or option trading, before allowing a user to submit a request to place a margin or option type trade. Therefore, if a user attempted to place a margin trade, the entity may prohibit the processing of that request, until the user has viewed and/or acknowledged a certain other Web page or series of such pages. Indeed, such a workflow prerequisite may be placed upon the trading page in combination with authentication and entitlement prerequisites. In general, any number of prerequisites, expressing arbitrary criteria, of which the foregoing categories of authentication, entitlement, and workflow are merely examples, may be placed upon appropriate Web pages at the site, in accordance with the entity's, desires.

Each of these types of prerequisites may be desired by the entity to be configured to prevent a user from having further access until the prerequisite(s) has been satisfied, while at the same time provide the user a means to satisfy the prerequisite(s) online. In keeping with the example presented above, assume a user has logged in to his or her financial account and attempts to place an option trade on a particular security. If, during that session, the user has not first viewed an information/disclaimer page regarding option trading, the system may prohibit the processing of the request. Instead, the system may automatically redirect the user to the page (or series of pages) which the user is to view as a prerequisite to entering the margin or option trade. Alternatively, the entity may simply respond to the user's request by instructing the user that the trade is not permitted until the user has viewed the particular page(s) required. In this case a hyperlink may be presented to the user for ease in beginning navigation through those page(s). In any case, the HTTP response issued by the system to the user when a prerequisite is lacked within a session is herein termed a “challenge”.

It will be appreciated that an indeterminate number of HTTP transactions may ensue between the challenge and the final satisfaction of the relevant prerequisite (an event herein called the “resolution”), as—depending on the prerequisite and the application—any number of Web pages may need to be visited first. In any case, in accordance with a principle aspect of one embodiment of the invention, when the user finally satisfies a prerequisite, it is often desired by the entity to return the user to the original Web page now interrupted due to the failed prerequisite (herein called the “target”). The HTTP response which serves to return the user to the target is herein called an “invitation”; just as a challenge response ensues from a failed prerequisite, an invitation response follows from a successful resolution.

In continuing with the example, the user may “surf” among a number of other pages on this site (and even visit other Web sites, so long as the “session” is not closed). Sometime later, the user may view the last of the page(s) required in order to satisfy the workflow prerequisite for the option/margin trading page. As soon as the user views this Web page (a resolution for the previously-unsatisfied prerequisite), the system may automatically take the user back to the target page in which the user was attempting to place an option or margin trade. Alternatively, the system may simply prompt the user that the prerequisite for placing an option/margin trade is now satisfied and present a hyperlink (or other mechanism) to the user for conveniently returning to that location, should the user so desire. Either response by the system thus constitutes an invitation to the user to resume at the target page.

The foregoing example illustrates a significant advancement of one embodiment of the present invention. Namely, when access to a given Web page has been denied based upon the failure to satisfy a certain prerequisite for access or entry to that Web page, the system of the invention thereafter monitors activities of the user, within the session, to determine when the failed prerequisite is satisfied. Once the failed prerequisite has been satisfied, the system of the invention is able to take the user to the prior target page, resuming the user's interrupted request. This is achieved regardless of the kind of prerequisite or resolution involved (whether authentication, entitlement, workflow, or otherwise); and regardless of the number or context of intervening HTTP transactions between the challenge and the invitation.

Having illustrated the operation of the invention, reference is now made to FIG. 2, which is a block diagram illustrating certain fundamental components of the present invention. As illustrated, a user at a client workstation 12 may request a desired Web page by submitting an HTTP request over the World Wide Web to a remote Web server 16. Of course, as previously discussed, the Web server 16 will include the components that are necessary, and well known, for processing HTTP requests and responding thereto, in accordance with the present state of the art. In addition, the Web server 16 includes components particular to the present invention, such as a component 102 for evaluating the HTTP request and determining whether there are prerequisites required for accessing that page, and if so, whether those prerequisites have been satisfied. The Web server 16 includes a component 104 for further processing and responding to the HTTP request with the proper Web page, assuming that component 102 identified all prerequisites as having been satisfied. The Web server 16 further includes a component 106 which is denoted as “Save State.” In the event that component 102 identifies any prerequisite to have not been satisfied in connection with the HTTP request, then component 106 is operative to save the current state and context of the user's session. In this regard, the state server component 106 will rely upon whatever solution for session state 108 is operative within the system (e.g., database, shared memory, HTTP cookie, etc.). The information saved by component 106 should not be confused with the session information that is conventionally stored by a Web server in the context of a given Web session. Rather, it includes additional information such as the target URL (i.e., the current URL), along with any queries or form arguments submitted therewith, and the identity of the prerequisite that was lacking. This information is later used (as further described herein) to return the user back to the state and context in which the user was in when the HTTP request was submitted, as though the request had been submitted with the prerequisite pre-satisfied.

Finally, the Web server 16 includes a component 110 denoted as “Challenge Response.” This component 110 operates to generate an appropriate HTTP response to the interrupted HTTP request. This response may include an identification to the user of the prerequisite that has not been met in order to access the desired Web page, as well as instruction in how the prerequisite may be satisfied by further activity. For example, an HTML document within the challenge response may be used to convey this information to the user. Alternately, HTTP headers within the challenge response may be used to automatically redirect the user's client 12 to another Web page which presents this information.

To further and more particularly illustrate the interruption of access to a Web page, as shown in FIG. 2, a pseudo-code algorithm of the interruption method is set forth below. The following algorithm is implemented as a component of server application program 18 on server 16. For example, in the embodiment where server application program 18 is based on a conventional HTTP daemon, the interruption algorithm is typically implemented as a library or class used by a server API plugin, servlet, CGI or FastCGI program constituting the application logic for the Web site. This interrupt algorithm is preferably executed by the server program 18 whenever an HTTP request is received for any target transaction recognized by the server. For such a target transaction, the interrupt algorithm is performed first, before the target transaction logic itself is conducted.

/* INTERRUPT ALGORITHM */
Target = The current Target
Prerequisites = All Prerequisite objects for the current Target, in

proper order of evaluation

/* Evaluate each Prerequisite object in turn; if any fail, interrupt
the

transaction. */

FOR EACH Prerequisite IN Prerequisites {

| | |
|---|---|
| EVALUATE Prerequisite | // Implementation varies among |

embodiments.

/* Proceed to next Prerequisite for evaluation if this one was

confirmed. */

| | |
|---|---|
| IF Prerequisite confirmed | { |

NEXT

}
/* But if this Prerequisite failed, store the current Target and

Prerequisite and respond with a Challenge. */

| | |
|---|---|
| ELSE | { |

/* Store the current Target and Prerequisite to session state,

where the Resume Algorithm (see below) will be able to find

it

later. Implementation of this varies; in some embodiments,

for

the Target a Target URL is what is saved, while in others a
Target HTTP Request object is saved. In some embodiments,

for

the Prerequisite a type string is what is saved, while in
others the Prerequisite object itself is saved. In some
embodiments, the Session state is a cookie; for other
implementations, it is a server-side Session object, file,

or

database. */

| | |
|---|---|
| NEW Interrupt object | // Make a new Interrupt |
| Interrupt.Target = Target | // Mark with current |

Target

| | |
|---|---|
| Interrupt.Prerequisite = Prerequisite | // Mark with current |

Prereq

| | |
|---|---|
| SAVE Interrupt to Session | // Store for Resume |

/* Issue a Challenge to the user. Challenges may vary based on

Target and Prerequisite. In some embodiments, some

Challenges

may take the form of HTTP response body content (e.g.,
particular HTML pages). In other embodiments, Challenges

may

use the HTTP Authenticate protocol or other HTTP-resident
mechanisms. */

| | |
|---|---|
| MAP (Target, Prerequisite) to Challenge | // Identify |

Challenge

| | |
|---|---|
| NEW Challenge | // Make the |

Challenge

| | |
|---|---|
| SEND Challenge in HTTP response | // Send the |

Challenge

STOP

}

}
/* All Prerequisites are satisfied for the Target at this point, so
the

Interrupt Algorithm is done. Return from this component and

continue

with the transaction logic for the Target. */

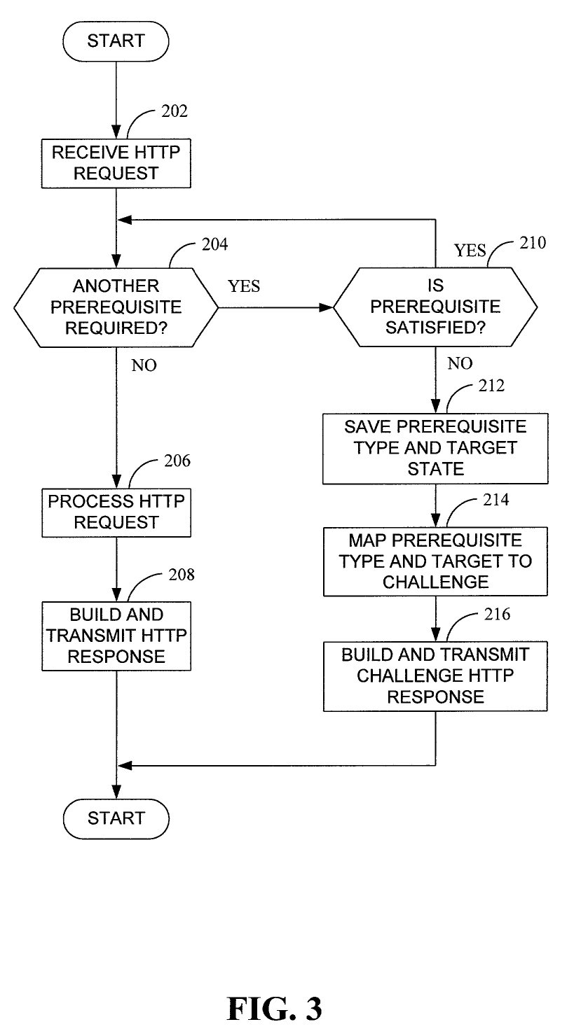

Reference is now made to FIG. 3, which is a flow diagram illustrating certain principal steps of the top-level operation of the system illustrated in FIG. 2, in accordance with one embodiment of the invention. Specifically, the methodology illustrated in FIG. 3 represents the operation of a Web server in carrying out the interruption algorithm.

In accordance with well-known Web server operation, the Web server receives an HTTP request (step 202). The Web server then evaluates that request to determine whether one or more prerequisites are required (step 204). If not, then the Web server processes the received HTTP request (step 206) and builds and transmits an appropriate HTTP response (step 208). It should be appreciated that the processing within steps 206 and 208 are carried out in ways that are known in the art (i.e., conventional responses to HTTP requests).

If, however, step 204 determines that one or more prerequisites are required, then the system determines whether the one or more prerequisites are satisfied (step 210). As illustrated, one way this process may be carried out is to evaluate one prerequisite at a time. If step 210 determines that the prerequisite is satisfied, then flow may return to step 204 to determine whether another prerequisite is required.

If the system determines that any prerequisite is not satisfied, then it saves the prerequisite type and target state (step 212). As illustrated, the target state includes such data as the current URL, query string, and form arguments (if any). In general, though, the target state is whatever data is necessary to store regarding the current HTTP request and its context within the session, such that it may be retrieved for resumption later. In this regard, and as discussed above, session state is utilized as the repository for this information, so that it will be available for resumption at any time, and any where, a resolution occurs later in the session. The actual nature of the session state repository utilized at step 212 may vary among embodiments of the invention; in general, any technique known in the art for the maintenance of session state is effective.

The system then maps the prerequisite type and target to an appropriate challenge to use as the HTTP response (step 214). Finally, the system builds and transmits the selected challenge HTTP response (step 216). In this regard, and as discussed above, the challenge is a response issued by the Web server to inform the user of the Web client that the requested target transaction has failed due to a lacking prerequisite. The challenge may further invite the user to engage in other transactions, which will preferably operate to satisfy the prerequisite. Accordingly, the mapping (step 214) is the process of generating the appropriate challenge based upon the type of prerequisite that failed, and the type of transaction targeted by the user. In this way, the system is able to render different challenges for different attempted transactions and reasons for their interruption, so that each challenge may be narrowly context-appropriate.

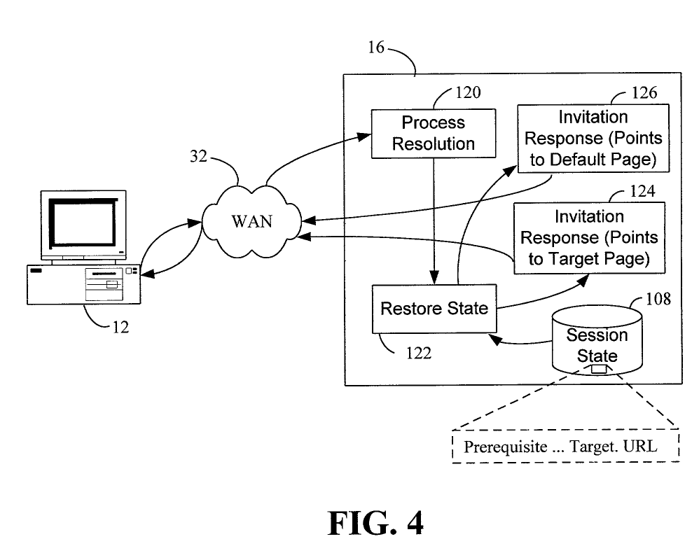

Reference is now made to FIG. 4, which is a diagram similar to FIG. 2, but illustrating additional components of the Web server 16 in accordance with another aspect of the present invention. In this regard, FIG. 2 illustrated the components of the Web server 16 that are implicated when a user submits a request for access to a given Web page, which access is denied based upon the failure to satisfy certain prerequisites. The diagram of FIG. 4 illustrates the additional components within the Web server 16 that are implicated when a prerequisite is later satisfied. In this regard, the Web server 16 includes a component 120, denoted “Process Resolution”, that receives a subsequent HTTP request from the user and identifies any prerequisite, which may have interrupted a previous request, and which has now been finally satisfied. Significantly, component 120 may identify the satisfaction of a prerequisite after many intervening HTTP transactions have occurred. The Web server 16 also includes a “Restore State” component 122, which operates to retrieve any appropriate state and context information corresponding to the satisfied prerequisite from the session state 108. This serves to recall both the state and context of the user session at the time when the previous target request failed. It should be noted that, conversely, component 122 may not identify any pending target for the prerequisite satisfied in component 120. This is the case when the user engaged in the resolution independently of any interrupted target. (For example, online registration may serve as the resolution for an authentication prerequisite, but not every online registration event will necessarily have an interrupted target waiting for it. Rather, some online registrations will occur voluntarily by the user, apart from any particular interruption in user workflow. In such cases, component 122 will find no particular, relevant target state awaiting restoration.)

In the event that component 122 does not identify a pending target corresponding to the kind of prerequisite just resolved, the Web server 16 includes a component 126 that generates a default invitation response. Such a response would direct the user to a reasonable default location for the particular resolution (for example, the Web site's home page), either by automatic redirect or by an optional hyperlink, depending on the embodiment.

But in the event a corresponding, pending target is found by component 122, the Web server 16 includes a component 124 that is configured to construct an appropriate invitation response for directing the user to the target page. In this regard, component 124 may, in some embodiments, be configured to automatically redirect the user to the target. Alternatively, component 124 may be configured to generate an invitation page, which includes a prompt for the user, advising the user that he may now have access to the target. This prompt may be further facilitated by providing a hyperlink to the target within the invitation, such that the user may conveniently open the hyperlink if he so chooses. For example, in the case where the interrupted target was a form submittal of some kind, the invitation response may include an HTML document containing the same form, pre-completed with the form arguments that were pending as part of the saved target state. The action reference for the pre-completed form, carried in the invitation response, would be the target URL.

Note that, should the target be re-requested by client 12 subsequent to the invitation, as the invention anticipates, the flow illustrated in FIG. 2 will repeat. Of course, the prerequisite check in component 102 will observe that the particular prerequisite, just resolved in FIG. 4, is now satisfied. But should another prerequisite remain unsatisfied for the page, another (probably different) challenge will be issued by component 110, after having re-saved the state for the target in component 106. Thus the flows illustrated in FIG. 2 and FIG. 4 continue until all prerequisites are satisfied, allowing component 104 to deliver the desired target page to the user.

To further and more particularly illustrate the resumption of access to a Web page, as shown in FIG. 4, a pseudo-code algorithm of the resumption method is set forth below. The following algorithm is implemented as a component of server application program 18 on server 16. For example, in the embodiment where server application program 18 is based on a conventional HTTP daemon, the resumption algorithm is typically implemented as a library or class used by a server API plugin, servlet, CGI or FastCGI program constituting the application logic for the Web site. This resumption algorithm is preferably executed by the server whenever an HTTP request is received, recognized by the server, and successfully processed as a resolution transaction. For such a resolution transaction, the resumption algorithm is performed last, after the resolution logic itself has been successfully conducted (but before an HTTP response has been sent to the client 12).

/* RESUME ALGORITHM */
Resolution = The current Resolution
Prerequisites = All Prerequisite objects satisfied by the current

Resolution

/* Fetch any relevant pending interrupt from session state. If there
is

one, build an Invitation containing the proper Target URL to be
resumed. If there is no relevant pending interrupt, build an
Invitation containing a default Target URL. */

| | |
|---|---|
| FETCH Interrupt from Session | // Implementation varies, see notes |
| above | |
| IF Interrupt EXISTS && | |

| | |
|---|---|
| Interrupt.Prerequisite IS IN Prerequisites | { |
| /* There was a relevant pending interrupt. | Identify the |

Invitation

to use for this kind of Resolution in this case; this can take
into account the kind of current Resolution, and (optionally)

the

kind of pending Target and kind of Prerequisite which caused

the

interrupt in the first place. Put the Target URL into the
Invitation, and send it to the HTTP client. */

| | |
|---|---|
| MAP (Resolution, | // Identify Invitation to |

use

Interrupt.Target,
Interrupt.Prerequisite) to Invitation

| | |
|---|---|
| NEW Invitation (Interrupt.Target URL) | // Make the Invitation to |
| | //include the Target URL |
| SEND Invitation in HTTP response | // Send the Invitation |
| ERASE Interrupt from Session | // Cleanup session state |

}
ELSE {

| | |
|---|---|
| /* There was no relevant pending interrupt. | Identify the |

Invitation

to use for this kind of Resolution in this case (it will

include a

| default Target URL, for example). Send that Invitation to the | |
|---|---|
| HTTP client. */ | |
| MAP Resolution to default Invitation | // Identify Invitation to |

use

| | |
|---|---|
| NEW Invitation | // Make the Invitation |
| SEND Invitation in HTTP response | // Send the Invitation |

}
STOP

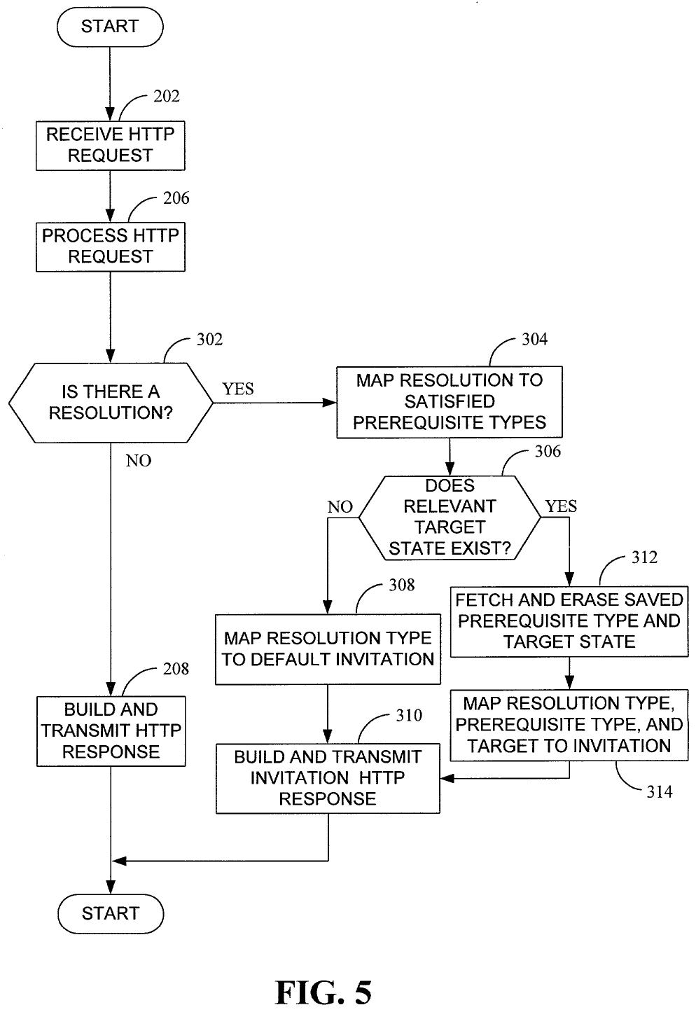

Reference is now made to FIG. 5, which is a flow diagram illustrating certain principal steps of the top-level operation of the system illustrated in FIG. 4, in accordance with one embodiment of the invention. Specifically, the methodology illustrated in FIG. 5 represents the operation of a Web server in carrying out the resumption algorithm. In FIG. 5, steps 202, 206, and 208 operate as described in connection with FIG. 3 (and known in the art).

After processing the HTTP request (step 206), the system determines (step 302) whether the processing performed in step 206 effectively serves as a resolution to any kind(s) of prerequisite. If not, then the system builds and transmits an HTTP response (step 208) appropriate for the HTTP request received and processed.

If, however, a resolution is achieved by the processing of the received HTTP request (step 206), then the system maps the resolution to the satisfied prerequisite type(s) (step 304). The system then checks the session state 108 to determine whether any target state exists for any of the satisfied prerequisite type(s) (step 306). Recall that such state, if it does exist, would have been created in FIG. 3 (step 212), while interrupting a previous target HTTP request which lacked a prerequisite, which has now, in FIG. 5, just been satisfied.

If such relevant target state exists, then the system fetches from the session state 108 the prerequisite type and the target state that was previously saved (step 312). In this regard, and as discussed above, the target state includes such data as the original URL for the request handled by FIG. 3, plus any query string or form arguments. In a preferred embodiment, the system also erases this information from the session state 108, once the information is retrieved therefrom. Such erasure is useful in maintaining a close association between interruptions and corresponding resumptions.

In any event, the system then maps the resolution type, prerequisite type, and the target to an appropriate invitation to use as the HTTP response (step 314). The system then builds the selected HTTP invitation response, and transmits the response to the user at the Web client (step 310). In this regard, and as discussed above, the invitation is a response issued by the Web server to inform the user of the Web client that the previously-failed prerequisite has been satisfied, and the pending target transaction may now be re-requested. In some embodiments, the invitation further provides means for re-requesting the target, either automatically or at the user's option. Accordingly, the mapping (step 314) is the process of generating the appropriate invitation based upon the target that was pending, the type of prerequisite that interrupted processing of the target, and the type of resolution that just occurred. In this way, the system is able to render different invitations that are narrowly context-appropriate.

Conversely, if step 306 determines that relevant target state does not exist, then it preferably maps the resolution type to some default invitation (step 308), and then builds an appropriate HTTP invitation response (from the default invitation). As discussed above, in this way resolutions that occur independently of an associated interruption event are handled. Such default invitations, resulting from these independent resolutions, commonly inform the user generally of the resolution, and/or direct the user (automatically or optionally) to a further, default location for continuation of the session experience (for example, a home page).

It should be appreciated that the foregoing describes the broader aspects of the preferred embodiment of the present invention, and that various alternative embodiments, and implementation details may be readily implemented by persons skilled in the art. For example, in certain environments a Web server may be implemented through a plurality of collaborating computers. Certain session information is copied or otherwise shared among the plurality of collaborating computers that collectively comprise the Web server. It should be appreciated that the present invention described herein is readily extendible to such a system.

The foregoing description has been presented for purposes of illustration and description. It is not intended to be exhaustive or to limit the invention to the precise forms disclosed. Obvious modifications or variations are possible in light of the above teachings. The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A method implemented at a Web server for controlling the interruption and resumption of access to a World Wide Web page to be supplied by the Web server and requiring at least one prerequisite, comprising:
receiving and evaluating a current HTTP request from a Web client to determine whether a previously unsatisfied prerequisite has been satisfied;
retrieving from a stored location information relating to a target HTTP request previously interrupted by the prerequisite, if the receiving and evaluating step determines that a previously unsatisfied prerequisite has been satisfied;
forming an HTTP response, which response includes contents for re-requesting from the Web client the target HTTP request; and
transmitting the response to the Web client that transmitted the current HTTP request.

2. The method according to claim 1, wherein the prerequisite is an authentication prerequisite.

3. The method according to claim 1, wherein the prerequisite is an entitlement prerequisite.

4. The method according to claim 1, wherein the prerequisite is a workflow prerequisite.

5. The method according to claim 1, wherein the information relating to the target HTTP request, retrieved from the stored location, includes the original target URL, queries, and form arguments.

6. The method according to claim 1, wherein the information relating to the target HTTP request, retrieved from the stored location, includes sufficient additional state information, so that re-request contents within the HTTP response are adequate for the Web client to repeat the target HTTP request as originally transmitted.

7. The method according to claim 1, wherein the information relating to the target HTTP request, retrieved from the stored location, includes the type of prerequisite previously unsatisfied for the target HTTP request.

8. The method according to claim 1, wherein the stored location uses client-side session state.

9. The method according to claim 1, wherein the stored location uses server-side session state.

10. The method according to claim 1, wherein the HTTP response formed includes content to cause the Web client to automatically re-request the target HTTP request.

11. The method according to claim 1, wherein the HTTP response formed includes content to inform and allow the user of the Web client to optionally re-request the target HTTP request.

12. A method implemented at a Web server for controlling the interruption and resumption of access to a World Wide Web page to be supplied by the Web server and requiring at least one prerequisite, comprising:
receiving and evaluating a current HTTP request from a Web client to determine whether an unsatisfied prerequisite exists;
saving to a stored location information concerning the current HTTP request, if the receiving and evaluating step determines that an unsatisfied prerequisite exists;
forming an HTTP response, which response omits desired contents from a location specified by the current HTTP request; and
transmitting the response to the Web client that transmitted the current HTTP request.

13. The method according to claim 7, wherein the prerequisite is an authentication prerequisite.

14. The method according to claim 7, wherein the prerequisite is an entitlement prerequisite.

15. The method according to claim 7, wherein the prerequisite is a workflow prerequisite.

16. The method according to claim 12, wherein the information saved to the stored location includes the current URL, queries, and form arguments.

17. The method according to claim 12, wherein the information saved to the stored location includes sufficient additional state information, so that an HTTP response may later be generated containing contents adequate for the Web client to re-request the current HTTP request as originally transmitted.

18. The method according to claim 12, wherein the information saved to the stored location further includes the type of prerequisite that is unsatisfied.

19. The method according to claim 12, wherein the stored location uses client-side session state.

20. The method according to claim 12, wherein the stored location uses server-side session state.

21. The method according to claim 12, wherein the HTTP response formed includes content to inform and allow the user of the Web client to optionally initiate activity to satisfy the unsatisfied prerequisite.

22. A Web server for controlling the interruption and resumption of access to a World Wide Web page to be supplied by the Web server and requiring at least one prerequisite comprising:
a first mechanism configured to evaluate a current HTTP request from a Web client to determine whether a previously unsatisfied prerequisite has been satisfied;
a second mechanism configured to retrieve from a stored location information relating to a target HTTP request previously interrupted by the prerequisite, in response to the first mechanism determining that a previously unsatisfied prerequisite has been satisfied;
a third mechanism configured to form an HTTP response, which response includes contents for re-requesting from the Web client the target HTTP request; and
a fourth mechanism configured to transmit the response to the Web client that transmitted the current HTTP request.

23. The Web server according to claim 22, wherein each of the first, second, third, fourth, and fifth mechanisms are implemented in software.

24. The Web server according to claim 22, further including a fifth mechanism configured to save to a stored location an original target URL, queries, and form arguments.

25. The Web server according to claim 22, further including a sixth mechanism configured to form an HTTP response, which response omits desired contents from a location specified by the original target URL.

26. The Web server according to claim 22, further including a seventh mechanism configured to transmit the response formed by the sixth mechanism to the user that transmitted the current HTTP request.

27. The Web server according to claim 22, wherein the Web server collectively comprises multiple computers that collaborate.

28. A Web server for controlling the interruption and resumption of access to a World Wide Web page to be supplied by the Web server and requiring at least one prerequisite comprising:
a first mechanism configured to evaluate a current HTTP request from a Web client to determine whether an unsatisfied prerequisite exists;
a second mechanism configured to save to a stored location information relating to the current HTTP request, in response to the first mechanism determining that an unsatisfied prerequisite exists;
a third mechanism configured to form an HTTP response, which response omits desired contents from a location specified by the current HTTP request; and
a fourth mechanism configured to transmit the response to the Web client that transmitted the current HTTP request.

29. The Web server according to claim 28, further including a fifth mechanism configured to determine, from the current HTTP request, whether a previously unsatisfied prerequisite has been satisfied.
